(19) United States
(12) Patent Application Publication
(10) Pub. No.: US 2024/0417307 A1
(43) Pub. Date: Dec. 19, 2024

(54) LOW-MELTING-POINT GLASS

(71) Applicant: AGC Inc., Tokyo (JP)

(72) Inventors: Naoya WADA, Tokyo (JP); Hiroyuki YAMAMOTO, Tokyo (JP); Jun MINAMIDATE, Tokyo (JP)

(73) Assignee: AGC Inc., Tokyo (JP)

(21) Appl. No.: 18/818,733

(22) Filed: Aug. 29, 2024

Related U.S. Application Data
(63) Continuation of application No. PCT/JP2023/006786, filed on Feb. 24, 2023.

(30) Foreign Application Priority Data
Mar. 2, 2022 (JP) 2022-032183

(51) Int. Cl. C03C 3/066; B32B 17/10; C03C 4/08; C08K 3/40

(52) U.S. Cl. CPC C03C 3/066; B32B 17/10; C03C 4/082; C08K 3/40; C08K 2201/003

(57) ABSTRACT

A glass includes, as represented by mol % of element: 12% to 16% of P; 16% to 21% of Sn; 50% to 60% of O; 5% to 15% of F; 0% to 3% of Zn; 0% to 1% of Si; 0% to 1% of B; and 0% to 3% of Al, and (Sn+Zn)/P is 1.25 to 1.55. A glass transition temperature Tg is 80° C. to 200° C. When an absorbance per 1 mm thickness at a wave number of 3100 cm⁻¹ is defined as A3100 and an absorbance per 1 mm thickness at a wave number of 3240 cm⁻¹ is defined as A3240 in an infrared absorption spectrum, A3240/A3100 is 0.6 to 1.2.

### CROSS-REFERENCE TO RELATED APPLICATIONS

This is a bypass continuation of International Patent Application No. PCT/JP2023/006786, filed on Feb. 24, 2023, which claims priority to Japanese Patent Application No. 2022-032183, filed on Mar. 2, 2022. The contents of these applications are hereby incorporated by reference in their entireties.

### TECHNICAL FIELD

The present invention relates to a glass, and particularly to a glass that has a low glass transition temperature (Tg), that can be subjected to low temperature forming, that prevents crystallization during forming, and that exhibits excellent moisture absorption resistance, a composite member containing the glass and a resin, and a sintered body and formed body thereof.

### BACKGROUND ART

Organic polymers (resins) are inferior to a glass in terms of heat resistance, light resistance, light transmitting property, and gas barrier property, but are used in a variety of applications because of having a low forming temperature and being inexpensive. On the other hand, the glass has excellent heat resistance, light resistance, light transmitting property, and gas barrier property, but a general glass has a high Tg and is difficult to be subjected to forming freely.

A low melting point glass is a glass material that has a melting temperature lower than that of a general glass, and is used as a coating for a metal surface or a glass surface, as an adhesive therebetween, or as a sealing material for an electronic product that requires higher airtightness than a resin-based material (for example, Patent Literature 1).

### CITATION LIST

### Patent Literature

Patent Literature 1: JP2010-505727A

### SUMMARY OF INVENTION

### Technical Problem

However, a low melting point glass in the related art has problems in that it is difficult to be transparent after low temperature forming since it is prone to crystallization, and a forming temperature margin is narrow due to the crystallization. Therefore, the low melting point glass in the related art is not suitable as a material for low temperature forming processes such as extrusion forming, injection forming, blow forming, and press forming, which are generally used in resin forming.

Further, since the low melting point glass in the related art absorbs moisture easily, glass properties may be unstable as a result of absorbing moisture from the air. Further, the gas barrier property of the glass may be decrease.

Therefore, an object of the present invention is to provide a glass that has a low Tg, that can be subjected to low temperature forming, that prevents crystallization during forming, and that has excellent moisture absorption resistance.

### Solution to Problem

As a result of studying the above problems, the inventors of the present invention have found that when the glass is made to have a specific composition range, in particular, a total content of Sn and Zn is made to be within a specific range, and a structure around the OH group in the glass is controlled, moisture absorption resistance and crystallization during forming are prevented, and the above problems can be solved. Thus, the present invention has been completed.

The present invention relates to a glass containing, as represented by mol % of element: 12% to 16% of P; 16% to 21% of Sn; 50% to 60% of O; 5% to 15% of F; 0% to 3% of Zn; 0% to 1% of Si; 0% to 1% of B; and 0% to 3% of Al, in which (Sn+Zn)/P is 1.25 to 1.55, a glass transition temperature Tg is 80° C. to 200° C., and when an absorbance per 1 mm thickness at a wave number of 3100 cm⁻¹ is defined as A3100 and an absorbance per 1 mm thickness at a wave number of 3240 cm⁻¹ is defined as A3240 in an infrared absorption spectrum, A3240/A3100 is 0.6 to 1.2.

### Advantageous Effects of Invention

The glass according to the present invention has a specific composition range, a Tg of 80° C. to 150° C., and excellent formability. In addition, when an absorbance per 1 mm thickness at a wave number of 3100 cm⁻¹ is defined as A3100 and an absorbance per 1 mm thickness at a wave number of 3240 cm⁻¹ is defined as A3240 in an infrared absorption spectrum, A3240/A3100 is in a specific range, and the structure around the OH group in the glass is controlled, so that crystallization is prevented. Accordingly, the glass according to the present invention has the advantage of exhibiting excellent transparency and moisture absorption resistance after low temperature forming.

### BRIEF DESCRIPTION OF DRAWINGS

FIG. 1A and FIG. 1B are schematic cross-sectional views of a glass-resin laminate according to one embodiment. FIG. 1C is a schematic cross-sectional view of a glass-resin sea-island composite according to one embodiment.

FIG. 2A to FIG. 2C are schematic diagrams showing a method for producing a glass-resin sea-island composite according to one embodiment.

FIG. 3 shows a DSC curve.

FIG. 4A and FIG. 4B are schematic cross-sectional views showing an example of a configuration of a packaging material having a sintered body or a formed body according to the present embodiment formed as a part thereof.

FIG. 5A to FIG. 5C are schematic cross-sectional views showing an example of a configuration of a phosphor-dispersed body having the sintered body or the formed body according to the present embodiment formed as a part thereof.

FIG. 6 is a schematic cross-sectional view showing an example of a configuration of an airtight sealing material 61 having the sintered body or the formed body according to the present embodiment formed as a part thereof.

FIG. 7 is a schematic cross-sectional view showing an example of a configuration of a vacuum double-glazed glass 71 having the sintered body or the formed body according to the present embodiment formed as a part thereof.

FIG. 8A to FIG. 8G are schematic cross-sectional views showing an example of a configuration of a lens or diffraction grating having the sintered body or the formed body according to the present embodiment formed as a part thereof.

### DESCRIPTION OF EMBODIMENTS

In the present description, “to” indicating a numerical range is used in the sense of including the numerical values set forth before and after the “to” as a lower limit value and an upper limit value, and unless otherwise specified, “to” is used hereinafter in the present description with the same meaning.

In the present description, a glass composition is expressed as a content of each element as represented by mol % unless otherwise specified, and mol % is simply expressed as “%”.

In the present description, “not substantially contained” means that a component has a content equal to or less than an impurity level contained in raw materials and the like, that is, the component is not intentionally added. In the present description, when it is described that a certain component is not substantially contained, a content of the component is specifically, for example, less than 0.1%.

In the present description, the term “parallel light transmittance” is a proportion of a parallel light beam emitted from a sample to a parallel light beam incident on the sample, and does not include scattered light. In addition, the term “haze rate” refers to a value measured in accordance with JIS K3761: 2000 using a C light source.

### <Glass>

### (Composition)

A glass according to the present invention contains, as represented by mol % of element:
12% to 16% of P;
16% to 21% of Sn;
50% to 60% of O;
5% to 15% of F;
0% to 3% of Zn;
0% to 1% of Si;
0% to 1% of B; and
0% to 3% of Al, and
(Sn+Zn)/P is 1.25 to 1.55.

Hereinafter, each composition range is described.

The content of P is 12% or more, preferably 13% or more, and more preferably 13.5% or more. When the content of P is 12% or more, the glass transition temperature Tg and the forming temperature can be lowered. The content of P is 16% or less, preferably 15.5% or less, and more preferably 15% or less. When the content of P is 16% or less, the moisture absorption resistance and the gas barrier property can be improved.

The content of Sn is 16% or more, preferably 16.5% or more, and more preferably 17% or more. When the content of Sn is 16% or more, the moisture absorption resistance and the gas barrier property can be improved. The content of Sn is 21% or less, preferably 20% or less, and more preferably 19% or less. When the content of Sn is 21% or less, the glass transition temperature Tg and the forming temperature can be lowered.

The content of O is 50% or more, preferably 51% or more, and more preferably 52% or more. When the content of O is 50% or more, a glass production process can be simplified and the moisture absorption resistance can be improved. The content of O is 60% or less, preferably 58% or less, and more preferably 56% or less. When the content of O is 60% or less, the glass transition temperature Tg and the forming temperature can be lowered.

The content of F is 5% or more, preferably 7% or more, more preferably 9% or more, and still more preferably 11% or more. When the content of F is 5% or more, the glass transition temperature Tg and the forming temperature are lowered, and crystallization is prevented. The content of F is 15% or less, preferably 14.5% or less, more preferably 14% or less, and still more preferably 13.5% or less. When the content of F is 15% or less, the moisture absorption resistance can be improved. In addition, the glass production process can be simplified, and generation of a HF gas during low temperature forming can be prevented.

The glass according to the present invention contains 0% to 3% of Zn. When Zn is contained, the glass transition temperature Tg is kept low, the crystallization can be prevented, and the coefficient of thermal expansion can be reduced. In the case where Zn is contained, the content thereof is preferably 0.1% or more, more preferably 0.5% or more, and still more preferably 1% or more. The content of Zn is 3% or less, preferably 2.5% or less, more preferably 2.2% or less, and still more preferably 2% or less, from the viewpoint of moisture absorption resistance.

The glass according to the present invention contains 0% to 1% of Si. When Si is contained, Si is incorporated into the skeleton, so that the glass can be stabilized and the moisture absorption resistance can be improved. In addition, the glass transition temperature Tg is kept low, and the coefficient of thermal expansion can be reduced. In the case where Si is contained, the content thereof is preferably 0.001% or more, more preferably 0.01% or more, and still more preferably 0.05% or more. The content of Si is 1% or less, preferably 0.5% or less, more preferably 0.3% or less, and still more preferably 0.1% or less, from the viewpoint of preventing the crystallization.

The glass according to the present invention contains 0% to 1% of B. When B is contained, the moisture absorption resistance can be improved. In addition, the glass transition temperature Tg is kept low, and the coefficient of thermal expansion can be reduced. In the case where B is contained, the content thereof is preferably 0.001% or more, more preferably 0.01% or more, and still more preferably 0.05% or more. The content of B is 1% or less, preferably 0.5% or less, more preferably 0.3% or less, and still more preferably 0.2% or less, from the viewpoint of preventing the crystallization.

The glass according to the present invention contains 0% to 3% of Al. When Al is contained, the moisture absorption resistance can be improved. In addition, the glass transition temperature Tg is kept low, and the coefficient of thermal expansion can be reduced. In the case where Al is contained, the content thereof is preferably 0.1% or more, more preferably 0.2% or more, and still more preferably 0.5% or more. The content of Al is 1% or less, preferably 3% or less, more preferably 2% or less, and still more preferably 1.5% or less, from the viewpoint of preventing the crystallization.

A total of the content of S and the content of Zn, that is Sn+Zn, is preferably 18% or more. When Sn+Zn is 18% or more, the crystallization, particularly crystallization of tin phosphate can be prevented. Sn+Zn is preferably 18.2% or more, more preferably 18.4% or more, and still preferably 18.5% or more. Sn+Zn is preferably 21% or less, more preferably 20.5% or less, still preferably 20% or less, and particularly preferably 19.5% or less. When Sn+Zn is 21% or less, the moisture absorption resistance can be improved.

A ratio of the total of the content of Sn and the content of Zn to the content of P, that is, (Sn+Zn)/P, is 1.25 to 1.55. When (Sn+Zn)/P is 1.25 or more, the crystallization, particularly precipitation of tin phosphate and zinc phosphate can be prevented. (Sn+Zn)/P is preferably 1.30 or more, and more preferably 1.32 or more. When (Sn+Zn)/P is 1.55 or less, the moisture absorption resistance of the glass can be improved, and a residual rate of F after melting and low temperature forming can be increased. (Sn+Zn)/P is preferably 1.50 or less, and more preferably 1.40 or less.

The glass according to the present invention may contain any compound and additive used in the glass, in addition to the components described above, as long as the contents of the components described above are within the above ranges, and as long as the effects of the present invention are achieved. For example, the following components may be contained.

The glass according to the present invention may contain 0% to 10% of Ba. When Ba is contained, the glass transition temperature Tg is kept low, the crystallization can be prevented, and the moisture absorption resistance can be improved.

The glass according to the present invention may contain Mg, Ca, and Sr in a total of 0% to 20%. When Mg, Ca, or Sr is contained, the moisture absorption resistance can be improved.

The glass according to the present invention may contain Li, Na, and K in a total of 0% to 20%. When Li, Na, or K is contained, the glass transition temperature Tg and the forming temperature can be lowered.

The glass according to the present invention may contain 0% to 3% of Zr. When Zr is contained, the crystallization can be prevented, and the moisture absorption resistance and the chemical resistance can be improved.

The glass according to the present invention may contain Ce and Y in a total of 0% to 5%. When Ce or Y is contained, the moisture absorption resistance and the chemical resistance can be improved.

The glass according to the present invention may contain Nb, W, Mo, and Ta in a total of 0% to 5%. When Nb, W, Mo, or Ta is contained, the moisture absorption resistance and the chemical resistance can be improved.

The glass according to the present invention may contain Fe, Ti, Mn, Cr, Cu, and Ag in a total of 0% to 10%. When Fe, Ti, Mn, Cr, Cu, or Ag is contained, the crystallization can be prevented, and the glass transition temperature Tg can be lowered.

The glass according to the present invention may contain Cl, Br, and I in a total of 0% to 20%. When Cl, Br, or I is contained, the moisture absorption resistance and the chemical resistance can be improved, and the crystallization can be prevented.

### (Glass Transition Temperature Tg)

The glass according to the present invention has a glass transition temperature Tg of 80° C. to 200° C. When the glass transition temperature Tg is 200° C. or lower, the glass has a low melting point, and can be used as a material for low temperature forming processes such as extrusion forming, injection forming, blow forming, and press forming, which are generally used in resin forming. In addition, a low melting point is also suitable for the purpose of sealing a phosphor (especially a quantum dot phosphor) without thermal degradation, and for the purpose of subjecting a glass to low temperature sintering without thermally degrading a surrounding member made of a metal, an organic substance, or the like. The glass transition temperature Tg is preferably 180° C. or lower, more preferably 160° C. or lower, and still more preferably 140° C. or lower. In addition, when the glass transition temperature Tg is 80° C. or higher, the coefficient of thermal expansion can be reduced, and the weather resistance and the moisture absorption resistance can be improved. The glass transition temperature Tg is preferably 100° C. or higher, more preferably 110° C. or higher, and still more preferably 120° C. or higher.

### (Infrared Absorption Spectrum)

In an infrared absorption spectrum of the glass according to the present invention, when an absorbance per 1 mm thickness at a wave number of 3100 cm⁻¹ is defined as A3100 and an absorbance per 1 mm thickness at a wave number of 3240 cm⁻¹ is defined as A3240, A3240/A3100 is 1.2 or less, preferably 1 or less, and more preferably 0.9 or less. When A3240/A3100 is 1.2 or less, the structure around the OH group in the glass can be properly controlled, and thereby the crystallization can be prevented. In addition, foaming can be prevented, so that a transparent formed body is obtained. A3240/A3100 is 0.6 or more, preferably 0.7 or more, and more preferably 0.8 or more. When A3240/A3100 is 0.6 or more, the glass production process can be simplified.

The infrared absorption spectrum near the wave number of 3100 cm⁻¹ and the wave number of 3240 cm⁻¹ represents the structure around the OH group in the glass. When the structure to be the skeleton of the glass is a P—O—Sn—O structure, during low temperature forming, elements are rearranged along with the volatilization of F and OH associated with the glass skeleton, and crystals of a tin phosphate compound are likely to generate. When the structure to be the skeleton of the glass is a P—O—Sn—O structure, a A3240 peak in the infrared absorption spectrum tends to be prominent, and A3240/A3100 is greater than 1.2. When the structure to be the skeleton of the glass is preferably a P—O—P—O structure, A3240/A3100 can be 1.2 or less. F and OH associated with the P—O—P—O structure are less likely to volatilize during low temperature forming, and even when F and OH volatilize, crystallization due to rearrangement of elements is less likely to occur. Since the volatilization of F and OH can be prevented, foaming is also less likely to occur, and the transparency is improved.

When ammonium dihydrogen phosphate (NH₄H₂PO₄) is used as a phosphate raw material for the glass, the structure to be the skeleton of the glass is a P—O—Sn—O structure, and crystals of a tin phosphate compound are likely to generate. Further, it is not preferable to use ammonium dihydrogen phosphate since a large amount of ammonia gas is generated during glass melting, which places a large burden on the environment, and foaming due to the ammonia gas occurs even during low temperature forming. On the other hand, when orthophosphoric acid (H₃PO₄) or orthophosphoric acid and stannous pyrophosphate (Sn₂P₂O₇) are used as the phosphate raw material for the glass, it is possible to obtain a glass having excellent transparency in which the structure to be the skeleton of the glass is a P—O—P—O structure and the crystallization and the foaming after melting and low temperature forming are less likely to occur. In addition, since the moisture contained in orthophosphoric acid acts to prevent the crystallization during low temperature forming in the glass, it is preferable to use orthophosphoric acid as the phosphate raw material for the glass.

In the glass according to the present invention, the absorbance per 1 mm thickness at a wave number of 3100 cm⁻¹ is preferably 0.2 to 4, more preferably 0.3 to 3, and still more preferably 0.5 to 2 in the infrared absorption spectrum. In addition, the absorbance per 1 mm thickness at a wave number of 3240 cm⁻¹ is preferably 0.12 to 4.8, more preferably 0.18 to 3.6, and still more preferably 0.3 to 2.4. When the absorbance per 1 mm thickness at a wave number of 3100 cm⁻¹ and the absorbance per 1 mm thickness at a wave number of 3240 cm⁻¹ are within the above ranges, the glass structure is controlled and is less prone to crystallization or foaming during low temperature forming, so that a formed body having excellent transparency can be obtained.

The infrared absorption spectrum is measured using a Fourier transform infrared spectrophotometer. When a transmittance at a wave number of 400 cm⁻¹ is defined as T400, a transmittance at a wave number of 3100 cm⁻¹ is defined as T3100, a transmittance at a wave number of 3240 cm⁻¹ is defined as T3240, and a thickness of a measurement sample is defined as D (mm), the absorbance A3100 per 1 mm thickness at a wave number of 3100 cm⁻¹ is calculated according to A3100=−log₁₀(T3100/T400)/D, and the absorbance A3240 per 1 mm thickness at a wave number of 3240 cm⁻¹ is calculated according to A3240=−log₁₀(T3240/T400)/D. Dividing by T400 is to correct a baseline in the measurement. Note that, the measurement sample is preferably processed into a flat plate having a thickness of 1 mm using cerium oxide free abrasive grains as a finishing agent.

### (Refractive Index)

The glass according to the present invention has a refractive index nd of 1.60 or more and 1.90 or less, preferably 1.65 or more and 1.85 or less, and more preferably 1.70 or more and 1.80 or less. The refractive index nd of the glass according to the present invention is greater than that of a resin having the same viscosity properties, and in the case where the glass according to the present invention is used in an optical member, the number of parts can be reduced.

### (Complex Viscosity)

In the glass according to the present invention, a temperature (T_{η=1000(-60° C.)}) at which a complex viscosity measured in a dry nitrogen atmosphere in a dew point of −60° C. is 1000 Pa·s is preferably 190° C. to 260° C. When T_{η=1000(-60° C.)} is 190° C. or higher, the stability and the weather resistance of the glass at room temperature can be improved. T_{η=1000(-60° C.)} is more preferably 200° C. or higher, and still more preferably 215° C. or higher. In addition, when T_{η=1000(-60° C.)} is 260° C. or lower, the glass is easily melted at a low temperature by firing in a dry atmosphere and low temperature forming is easy. In addition, in an application as a sealing material, the glass can be subjected to low temperature sintering without thermally deteriorating a phosphor (especially a quantum dot phosphor) or a surrounding member made of a metal, an organic substance, or the like. T_{η=1000(-60° C.)} is more preferably 250° C. or lower, and still more preferably 240° C. or lower.

A temperature (T_{η=1000(0° C.)}) at which the complex viscosity measured in an air atmosphere in a dew point of 0° C. is 1000 Pa·s is preferably 10° C. or more higher than the above temperature (T_{η=1000(-60° C.)}) at which the complex viscosity measured in a dry nitrogen atmosphere in a dew point of −60° C. is 1000 Pa·s. When the temperature difference between T_{η=1000(0° C.)} and T_{η=1000(-60° C.)} is 10° C. or more, the heat resistance can be improved when the glass is used in the air. The temperature difference between T_{η=1000(0° C.)} and T_{η=1000(-60° C.)} is more preferably 15° C. or more, and still more preferably 20° C. or more. In addition, when the temperature difference between T_{η=1000(0° C.)} and T_{η=1000(-60° C.)} is 100° C. or less, low temperature forming or low temperature sintering can be performed stably even when the atmosphere changes. The temperature difference between T_{η=1000(0° C.)} and T_{η=1000(-60° C.)} is more preferably 50° C. or less, and still more preferably 40° C. or less.

The complex viscosity is determined based on a viscoelasticity measured in accordance with JIS K7244-10:2005 using a rheometer MCR502 manufactured by Anton Paar GmbH, at a frequency of 1 Hz and a shear strain of 0.1%.

### (Moisture Absorption Amount)

In the glass according to the present invention, a weight increase amount per unit surface area is preferably 5 mg/cm² or less, more preferably 2 mg/cm² or less, and still more preferably 0.5 mg/cm² or less, after storage for 5 hours in an atmosphere at a temperature of 60° C. and a relative humidity of 90%. When the weight increase amount is 5 mg/cm² or less, excellent moisture absorption resistance is exhibited. The weight increase amount is not particularly limited in lower limit, and is generally 0.01 mg/cm² or more.

### (Differential Scanning Calorimetry)

In the glass according to the present invention, a difference between a crystallization peak temperature Tc and the glass transition temperature Tg in differential scanning calorimetry is preferably 150° C. or more, more preferably 160° C. or more, and still more preferably 170° C. or more. Note that, it is most preferred that Tc is not observed, and in this case, the difference between Tc and Tg can be interpreted as being infinite. When the difference between Tc and Tg is 150° C. or more, a gap between the formable temperature and the crystallization temperature, that is, a forming temperature margin, is widened, and a glass having more excellent transparency can be obtained after low temperature forming or low temperature sintering. Note that, at a temperature equal to or higher than Tc, the viscosity increases rapidly due to crystallization of the glass, making the low temperature forming difficult.

In the glass according to the present invention, a difference between a crystallization start temperature Tx and the glass transition temperature Tg in the differential scanning calorimetry is preferably 140° C. or more, more preferably 150° C. or more, and still more preferably 160° C. or more. Note that, it is most preferred that Tx is not observed, and in this case, the difference between Tx and Tg can be interpreted as being infinite. When the difference between Tx and Tg is 140° C. or more, a gap between the formable temperature and the crystallization start temperature is widened, and a glass having more excellent transparency can be obtained after low temperature forming or low temperature sintering.

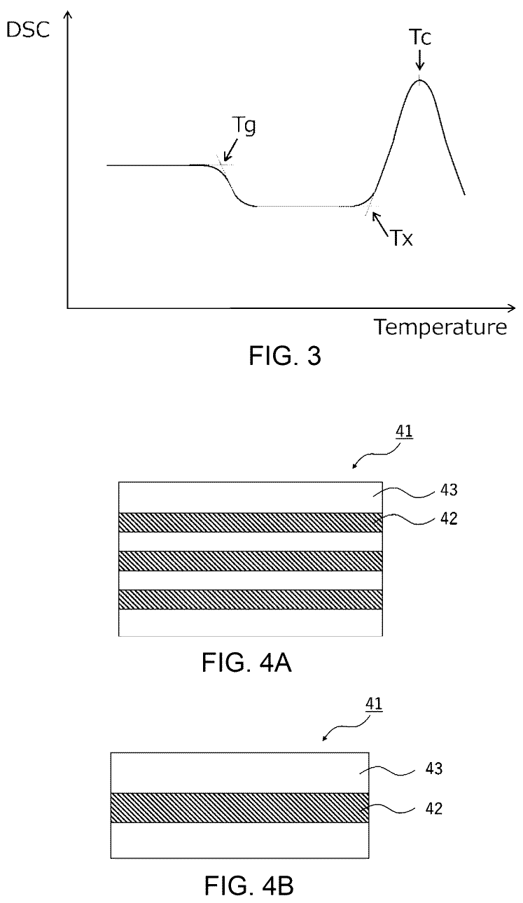

The differential scanning calorimetry is performed by using a powder having a median diameter of less than 3 microns, which is pulverized in an agate mortar, as a measurement sample, under a conditions of raising the temperature from 25° C. to 500° C. at a rate of 2° C./min in an air atmosphere. As shown in FIG. 3, in a DSC curve, Tg is a temperature at which the curve first undergoes an endothermic shift during a temperature rise process, Tx is a temperature at which heat generation due to crystallization first starts during the temperature rise process, and Tc is a peak temperature of heat generated due to crystallization that first occurs during the temperature rise process.

### (Weight Reduction Rate During Forming)

In the glass according to the present invention, a weight reduction rate before and after a heat treatment at (Tg+150° C.) for 1 hour is preferably 2% or less, more preferably 1% or less, and still more preferably 0.7% or less. (Tg+150° C.) is a temperature same as a temperature during low temperature forming, and when the weight reduction rate is 2% or less, the moisture content in the glass is not too high, foaming during low temperature forming is prevented, and a formed body having excellent transparency can be obtained. The lower limit of the weight reduction rate is preferably 0.1% or more, more preferably 0.2% or more, and still more preferably 0.3% or more. When the weight reduction rate is 0.1% or more, the presence of the moisture in the glass prevents the crystallization during low temperature forming, and a formed body having excellent transparency can be obtained.

The weight reduction before and after a heat treatment at (Tg+150° C.) for 1 hour is measured under the following conditions.

The weight of a sample is measured by using a thermogravimetric differential thermal analyzer. As the measurement sample, a powder having a median diameter of less than 3 microns, which is pulverized in an agate mortar, is used. The measurement conditions are as follows: the temperature is raised from 25° C. to (Tg+150° C.) at a rate of 2° C./min in an air atmosphere, and the temperature is maintained at (Tg+150° C.) for 1 hour. At this time, the weight reduction rate relative to the initial weight is evaluated.

### (Parallel Light Transmittance)

In the glass according to the present invention, an average value of parallel light transmittance in a wavelength range of 400 nm to 700 nm measured in a thickness direction on a flat plate having a thickness of 1 mm is preferably 70% or more, more preferably 80% or more, and still more preferably 85% or more. When the average value is 70% or more, a glass having excellent transparency and prevented crystallization can be obtained. In addition, when a glass having the average value of 70% or more is used for low temperature forming, a formed body having high transparency can be obtained. The average value is not particularly limited in upper limit, and is typically 92% or less. Note that, the measurement sample is preferably processed into a flat plate having a thickness of 1 mm using cerium oxide free abrasive grains as a finishing agent.

### (Haze Rate)

In the glass according to the present invention, a haze rate measured in the thickness direction on a flat plate having a thickness of 1 mm is preferably 20% or less, more preferably 15% or less, and still more preferably 10% or less. When the haze rate is 20% or less, a glass having excellent transparency and prevented crystallization can be obtained. The haze rate is not particularly limited in lower limit, and is typically 0.2% or more. Note that, the measurement sample is preferably processed into a flat plate having a thickness of 1 mm using cerium oxide free abrasive grains as a finishing agent.

### (Production Method)

The glass according to the present invention can be produced by a method of mixing and melting glass raw materials, followed by cooling. In the glass according to the present invention, it is preferable to use orthophosphoric acid (H₃PO₄) as the phosphate raw material for the glass. In the case of using orthophosphoric acid, in order to remove moisture from orthophosphoric acid, drying may be performed at a temperature of 100° C. to 500° C. for about 10 minutes to 50 hours before melting. Only orthophosphoric acid may be dried and then mixed with other raw materials, or orthophosphoric acid may be mixed with some or all of other raw materials and then dried. The raw materials are charged into a container made of platinum, carbon, quartz, alumina, nickel, or the like, and melted at a temperature of 400° C. to 700° C. for about 10 minutes to 10 hours. All of the raw materials may be melted at once, or only a portion or a specific raw material may be melted first, and the remaining raw materials may be melted later. If desired, the molten glass may be formed into desired shapes, such as a frit, a pellet, or a flake, by various methods.

### <Glass Frit>

The glass according to the present invention may be made into a glass frit in the form of a powder. By being made into a frit form, the glass can be applied to processes such as printing, dispensing, coating, and powder compaction. The glass frit has an average particle diameter (d50) of preferably 0.5 μm or more. When the average particle diameter (d50) is 0.5 μm or more, excessive air bubbles can be prevented from being mixed into a low temperature sintered body. The average particle diameter (d50) is preferably 1 μm or more, and more preferably 1.5 μm or more. In addition, the average particle diameter (d50) is preferably 10 μm or less. When the average particle diameter (d50) is 10 μm or less, a surface roughness of the low temperature sintered body can be reduced, and a printing film thickness can be reduced. The average particle diameter (d50) is more preferably 5 μm or less, and still more preferably 3 μm or less. The average particle diameter (d50) is determined by a laser diffraction method. A method for producing the glass frit is not particularly limited, and for example, the glass frit can be obtained by pulverizing the glass according to the present invention. Therefore, the particle size of the glass is determined by pulverization conditions. Examples of the pulverization method include a rotary ball mill, a vibrating ball mill, a planetary mill, a jet mill, an attritor, a media stirring mill (bead mill), a jaw crusher, and a roll crusher.

### <Glass Frit Paste>

The glass according to the present invention may be made into a frit paste by dispersing a powdered glass in a solvent and mixing a resin component to adjust the viscosity. Examples of the resin for use in the frit paste include ethyl cellulose, nitrocellulose, an acrylic resin, vinyl acetate, a butyral resin, a melamine resin, an alkyd resin, and a rosin resin.

In addition, examples of the solvent for use in the frit paste include ether-based solvents (butyl carbitol (BC), butyl carbitol acetate (BCA), diethylene glycol di-n-butyl ether, dipropylene glycol butyl ether, tripropylene glycol butyl ether, butyl cellosolve acetate, ethylene glycol monophenyl ether, diethylene glycol monoethyl ether, and dipropylene glycol monomethyl ether), alcohol-based solvents (α-terpineol, pine oil, and DOWANOL), glycol-based solvents (propylene glycol, ethylene glycol, diethylene glycol, dipropylene glycol, and tripropylene glycol), ketone-based solvents (isophorone and cyclohexenone), ester-based solvents (2,2,4-trimethyl-1,3-pentanediol monoisobutyrate), and phthalate ester-based solvents (DBP (dibutyl phthalate), DMP (dimethyl phthalate), and DOP (dioctyl phthalate)).

A content of the glass in the frit paste is preferably 55 mass % to 90 mass %, more preferably 65 mass % to 85 mass %, and still more preferably 70 mass % to 80 mass %. A content of the resin in the frit paste is preferably 0 mass % to 10 mass %, more preferably 1 mass % to 7 mass %, and still more preferably 2 mass % to 5 mass %. A content of the solvent in the frit paste is preferably 10 mass % to 45 mass %, more preferably 15 mass % to 40 mass %, and still more preferably 20 mass % to 35 mass %.

The frit paste may contain an inorganic powder or a phosphor. The inorganic powder is added for the purpose of imparting scattering properties, improving strength, reducing thermal expansion, and the like. Examples of the inorganic powder include silicon oxide, aluminum oxide, zirconium oxide, titanium oxide, zirconium phosphate, zirconium tungstate phosphate, and cordierite. A content of the inorganic powder is preferably 0.01 mass % to 30 mass %, more preferably 1 mass % to 20 mass %, and still more preferably 5 mass % to 10 mass %.

Examples of the phosphor include an oxide, an oxynitride, a nitride, and semiconductor nanoparticles (quantum dot). A content of the phosphor is preferably 0.01 mass % to 30 mass %, more preferably 1 mass % to 20 mass %, and still more preferably 5 mass % to 10 mass %. When the frit paste containing a phosphor is subjected to low temperature sintering or low temperature forming, the phosphor can be sealed and dispersed in the glass.

### <Glass Pellet>

The glass according to the present invention may be in the form of a glass pellet. By being made into a pellet form, the glass is easily charged into a low temperature forming machine. The glass pellet has a long diameter of preferably 0.1 mm to 5 mm. The lower limit of the long diameter of the glass pellet is more preferably 1 mm or more, and still more preferably 2 mm or more. In addition, the upper limit of the long diameter of the glass pellet is more preferably 4.5 mm or less, and still more preferably 4 mm or less.

The glass pellet has a short diameter of preferably 0.1 mm to 5 mm. The lower limit of the short diameter of the glass pellet is more preferably 0.5 mm or more, and still more preferably 1.5 mm or more. In addition, the upper limit of the short diameter of the glass pellet is more preferably 4.5 mm or less, and still more preferably 4 mm or less. When the diameter and the short diameter of the glass pellet are within the above ranges, the glass pellet is easy to screw-transport in a forming machine and is less likely to be damaged inside the forming machine. Further, the glass is less prone to crystallization during low temperature forming.

A ratio of the short diameter to the long diameter of the glass pellet is preferably 0.2 to 1, more preferably 0.5 to 1, and still more preferably 0.7 to 0.95, from the viewpoint of preventing breakage of the glass pellet in the forming machine.

A method for producing the glass pellet is not particularly limited, and examples thereof include a pressing method using a mold, a method of pulverizing a glass by using water, a drop forming method, a method of remelting a glass powder, a method of breaking a melt into small pieces and throw them away, a method of subjecting a glass to extrusion forming to obtain strands and then cut the strands with a pelletizer, and a method of cutting a plate glass into small pieces.

The glass pellet may contain an inorganic powder or a phosphor. The inorganic powder is added for the purpose of imparting scattering properties, improving strength, reducing thermal expansion, and the like. As the inorganic powder, silicon oxide, aluminum oxide, zirconium oxide, titanium oxide, zirconium phosphate, zirconium tungstate phosphate, cordierite, and the like are used. A content of the inorganic powder is preferably 0.01 vol % to 50 vol %, more preferably 1 vol % to 30 vol %, and still more preferably 10 vol % to 25 vol %. As the phosphor, an oxide, an oxynitride, a nitride, semiconductor nanoparticles (quantum dot), and the like are used. A content of the phosphor is preferably 0.01 vol % to 50 vol %, more preferably 1 vol % to 30 vol %, and still more preferably 10 vol % to 25 vol %. When the glass pellet containing a phosphor is subjected to low temperature sintering or low temperature forming, the phosphor can be sealed and dispersed in the glass.

The glass pellet may contain air bubbles. The air bubbles are added for the purpose of imparting scattering properties, and the like. A content of the air bubbles is preferably 0.01 vol % to 50 vol %, more preferably 1 vol % to 30 vol %, and still more preferably 5 mass % to 20 mass %.

### (Low Temperature Forming and Low Temperature Sintering)

The glass according to the present invention is preferably used in low temperature forming, which is at least one of extrusion forming, injection forming, blow forming, and press forming, or low temperature sintering at preferably 400° C. or lower, more preferably 300° C. or lower, and still more preferably 250° C. or lower. Since the glass according to the present invention has a Tg of 80° C. to 150° C. and A3240/A3100 of 1.2 or less as described above, even when used in a low temperature forming process preferably at 400° C. or lower, the crystallization is prevented, and a formed body or a sintered body having excellent transparency can be obtained.

### <<Mixed Glass-Resin Frit>>

The glass frit may be a mixed glass-resin frit obtained by mixing the glass frit according to the present invention with a resin. As the resin, either a thermosetting resin or a thermoplastic resin can be applied. From the viewpoint of easy compositing with a glass, a thermoplastic resin is preferred, and a resin having an acid group and an amino group is preferred. The resin having an acid group and an amino group easily chemically bonds with the low melting point glass according to the present invention. The resin may be in the form of a powder, and in this case, the average particle diameter (d50) is preferably 0.5 μm to 10 μm.

Examples of the thermosetting resin include an epoxy-based resin, a phenol-based resin, a urea resin, a melamine resin, a silicone resin, an unsaturated polyester resin, and a polyurethane resin.

Examples of the thermoplastic resin include nylon, a polyacetal, a polysulfone, a polyetherimide, a polyamideimide, a liquid crystal polymer, a polytetrafluoroethylene, a polychlorotrifluoroethylene, a polyvinylidene difluoride, an aromatic polyether, a polyphenylene ether, a polyether ether ketone, a polyphenylene oxide, a polycarbonate, a polyethylene, a polyethylene terephthalate, a polybutylene terephthalate, a polyethylene naphthalate, a polyethersulfone, a polypropylene, a polystyrene, an acrylonitrile butadiene styrene, an acrylic, a polyvinyl chloride, a polyarylate, a polyoxybenzoyl polyester, a cycloolefin polymer, and a cycloolefin copolymer.

From the viewpoint of easy compositing with a glass, the viscosities of the glass and the resin are preferably approximately the same in a forming temperature range.

In the mixed glass-resin frit according to the present invention, the blending ratio of the glass and the resin can be appropriately set in consideration of the application of the composite material composition, and is not particularly limited. For example, use can be made by mixing and compositing the glass and the resin in a range of glass:resin=1:99 to 99.9:0.1 (volume ratio).

### <<Glass-Resin Composite Pellet>

The glass pellet may be a glass-resin composite pellet obtained by compositing the glass according to the present invention and a resin. As the resin, either a thermosetting resin or a thermoplastic resin can be applied. From the viewpoint of easy compositing with a glass, a thermoplastic resin is preferred, and a resin having an acid group and an amino group is preferred. The resin having an acid group and an amino group easily chemically bonds with the low melting point glass according to the present invention.

Examples of the thermosetting resin include an epoxy-based resin, a phenol-based resin, a urea resin, a melamine resin, a silicone resin, an unsaturated polyester resin, and a polyurethane resin.

Examples of the thermoplastic resin include nylon, a polyacetal, a polysulfone, a polyetherimide, a polyamideimide, a liquid crystal polymer, a polytetrafluoroethylene, a polychlorotrifluoroethylene, a polyvinylidene difluoride, an aromatic polyether, a polyphenylene ether, a polyether ether ketone, a polyphenylene oxide, a polycarbonate, a polyethylene, a polyethylene terephthalate, a polybutylene terephthalate, a polyethylene naphthalate, a polyethersulfone, a polypropylene, a polystyrene, an acrylonitrile butadiene styrene, an acrylic, a polyvinyl chloride, a polyarylate, a polyoxybenzoyl polyester, a cycloolefin polymer, and a cycloolefin copolymer.

From the viewpoint of easy compositing with a glass, the viscosities of the glass and the resin are preferably approximately the same in a forming temperature range.

A method for producing the glass-resin composite pellet is not particularly limited, and examples thereof include a method of pelletizing a molten material obtained by melt-kneading a glass component, a resin component, and optionally other components by using a twin-screw kneading extruder or the like, and a method of subjecting a glass pellet and a resin pellet to thermal press bonding.

In the glass-resin composite pellet according to the present invention, the blending ratio of the glass and the resin can be appropriately set in consideration of the application of the composite material composition, and is not particularly limited. For example, use can be made by mixing and compositing the glass and the resin in a range of glass:resin=1:99 to 99:1 (volume ratio).

### <<Other Components>>

In the present invention, the mixed glass-resin frit, the frit paste, and the glass pellet may contain one or more fillers, additives and the like, as required. The filler may be a plate-like filler, a spherical filler or a particulate filler. The filler may be an inorganic filler or an organic filler. Examples of the additive include a flame retardant, a conductivity imparting agent, a crystal nucleating agent, a UV absorber, an antioxidant, a vibration damper, an antibacterial agent, an insect repellent, a deodorant, a color inhibitor, a heat stabilizer, a release agent, an antistatic agent, a plasticizer, a lubricant, a colorant, a pigment, a dye, a foam inhibitor, a viscosity modifier, and a surfactant.

### <Sintered Body>

A sintered body according to the present invention is obtained by subjecting the above glass frit made of the glass according to the present invention (a frit containing only a glass or a mixed glass-resin frit), or the above frit paste containing the glass according to the present invention to low temperature firing. When the glass undergoes crystallization during firing, the sintered body loses transparency and fluidity during firing, making it difficult to control the shape and thus difficult to achieve airtight sealing. Since the glass according to the present invention is prevented from crystallizing or foaming during firing, a sintered body having excellent shape stability and gas barrier property can be obtained. In addition, since the crystallization and the foaming during firing can be prevented, a sintered body having excellent transparency can be obtained.

Examples of a method for forming the sintered body according to the present invention include a method of firing a glass frit in the form of a powder, a method of making a glass frit into a compact and then performing firing, and a method of applying a frit paste onto a glass, resin, metal, or other member and performing firing.

The sintered body according to the present invention preferably has a good gas barrier property. Specifically, a water vapor permeability under conditions of a temperature of 40° C. and a relative humidity of 90% is preferably 1 g/m²/day or less, more preferably 0.1 g/m²/day or less, still more preferably 0.01 g/m²/day or less, and particularly preferably 0.001 g/m²/day or less.

Examples of the form of the sintered body according to the present invention include a glass sintered body, and a glass-resin composite. The sintered body may be formed by firing a glass powder without forming the glass frit. Alternatively, a frit paste may be applied in the form of a film and then fired. The surface may be smooth or may have irregularities.

### <Formed Body>

A formed body according to the present invention contains the glass according to the present invention and obtained by forming, into a desired shape, the above glass frit or the above glass pellet (a frit or a pellet containing only a glass, a glass-resin composite frit, or a glass-resin composite pellet) by low temperature forming such as extrusion forming, injection forming, blow forming, and press forming. When the glass undergoes crystallization or foaming during forming, the forming is difficult and the formed body loses transparency. Since the glass according to the present invention is prevented from crystallizing or foaming during forming, a formed body having excellent adhesive strength and transparency can be obtained in the case of compositing with a resin. From the viewpoint of ensuring the transparency, an average value of parallel light transmittance in a wavelength range of 400 nm to 700 nm of the formed body in a thickness direction is preferably 60% or more, more preferably 70% or more, and still more preferably 80% or more. The parallel light transmittance is not particularly limited in upper limit, and is typically 92% or less. In addition, from the viewpoint of ensuring the transparency, a haze rate of the formed body in the thickness direction is preferably 20% or less, more preferably 15% or less, and still more preferably 10% or less. The haze rate is not particularly limited in lower limit, and is typically 0.2% or more.

The formed body according to the present invention preferably has a good gas barrier property. Specifically, a water vapor permeability under conditions of a temperature of 40° C. and a relative humidity of 90% is preferably 1 g/m²/day or less, more preferably 0.1 g/m²/day or less, still more preferably 0.01 g/m²/day or less, and particularly preferably 0.001 g/m²/day or less. Note that, in the case where the moisture absorption resistance of the glass is poor, the glass is altered by absorbing moisture, and as a result, the gas barrier property is greatly decreased.

Examples of the form of the formed body according to the present invention include a glass formed body, and a glass-resin composite. The shape of the formed body may be a plate or a film, or may be a three-dimensional shape such as a cylinder, a column, a prism, a bottle, a syringe, or a container. In the case of a plate or a film, the shape is not limited to a rectangle, or may be a polygon, a circle, or an ellipse. The surface may be smooth or may have irregularities.

A thickness of the formed body is not particularly limited, and is preferably 0.01 mm to 10 mm, more preferably 0.02 mm to 3 mm, and still more preferably 0.05 mm to 1 mm. When the thickness of the formed body is 0.01 mm or more, the strength can be improved, and the gas barrier property can be improved. When the thickness of the formed body is 5 mm or less, the weight can be reduced.

The sintered body and the formed body according to the present invention may contain an inorganic substance as a filler. Examples of the filler include silicon oxide, aluminum oxide, zirconium oxide, titanium oxide, zirconium phosphate, zirconium tungstate phosphate, and cordierite.

A content proportion of the filler is preferably 0.01 vol % to 50 vol %, more preferably 1 vol % to 30 vol %, and still more preferably 10 vol % to 25 vol %, with respect to a total volume of the glass component and the filler. When the content proportion of the filler is 0.01 vol % or more, the strength of the sintered body and the formed body or adhesion to other members is improved. In addition, when the content proportion of the filler is 50 vol % or less, the fluidity during low temperature sintering and low temperature forming can be maintained. The content proportion is preferably 0.01 vol % to 50 vol %, more preferably 1 vol % to 30 vol %, and still more preferably 10 vol % to 25 vol %.

The sintered body and the formed body according to the present invention exhibits excellent transparency and may contain a phosphor. In addition, the glass according to the present invention has a low viscosity during forming, making it easy to disperse the phosphor in the glass. Examples of the phosphor include a quantum dot phosphor, an oxide, an oxynitride, a nitride, and semiconductor nanoparticles (quantum dot). These phosphors may deteriorate over time due to oxygen or water, but by dispersing the phosphors in the glass, this deterioration over time can be prevented.

A content proportion of the phosphor is preferably 0.01 vol % to 50 vol %, more preferably 1 vol % to 30 vol %, and still more preferably 10 vol % to 25 vol %, with respect to a total volume of the glass component and the phosphor. When the content proportion of the phosphor is 0.01 vol % or more, effective color conversion can be achieved. In addition, when the content proportion of the phosphor is 50 vol % or less, the fluidity during low temperature sintering and low temperature forming can be maintained.

Examples of a method for containing the phosphor in the sintered body or the formed body according to the present invention include a method of subjecting a glass pellet containing a phosphor to low temperature forming, a method of firing a glass paste containing a phosphor, and a method of firing a glass frit mixed with a phosphor.

### <<Glass-Resin Composite>>

Examples of the glass-resin composite include 1) a glass-resin laminate and 2) a glass-resin sea-island composite. When the glass component undergoes crystallization or foaming, low temperature forming of a composite formed body is difficult, and the adhesive strength between the resin and the glass and the transparency decrease. Since the glass according to the present invention is prevented from crystallizing or foaming during low temperature forming, a composite having excellent adhesive strength and transparency can be obtained in the case of compositing with a resin. From the viewpoint of ensuring the transparency, an average value of parallel light transmittance in a wavelength range of 400 nm to 700 nm of the composite in a thickness direction is preferably 60% or more, more preferably 70% or more, and still more preferably 80% or more. The parallel light transmittance is not particularly limited in upper limit, and is typically 92% or less.

### 1) Glass-Resin Laminate

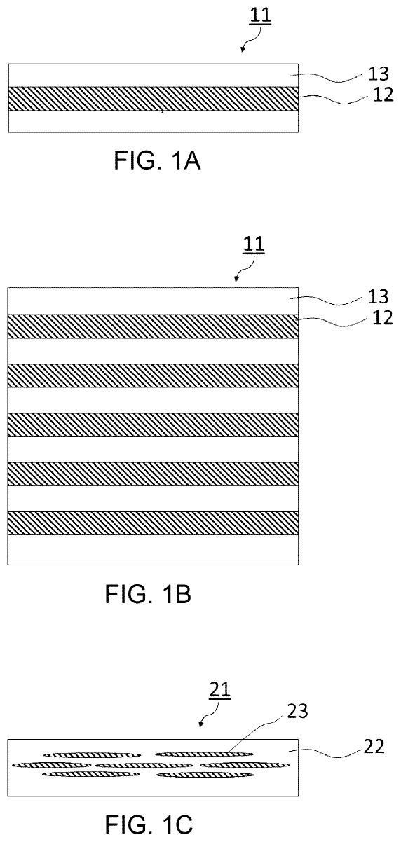

FIG. 1A and FIG. 1B show schematic cross-sectional views of a glass-resin laminate according to one embodiment. As shown in FIG. 1A and FIG. 1B, a glass-resin laminate 11 is a laminate having two or more layers, preferably three or more layers, in which a resin layer 13 is laminated on one or both surfaces of a glass layer 12. From the viewpoint of the formability and the strength, the outermost layer is preferably made of a resin.

In the glass-resin laminate, a content ratio (mass ratio) of the glass layer to the resin layer is preferably 1:99 to 80:20, and more preferably 10:90 to 60:40, from the viewpoints of the gas barrier property and weight reduction.

The glass-resin laminate is obtained by separately melting a glass component (for example, the above glass frit and glass pellet) and a resin component (for example, a resin pellet), followed by lamination, compositing, and low temperature forming such as extrusion forming, injection forming, blow forming, and press forming.

An interface between the glass layer and the resin layer in the glass-resin laminate is preferably a mixed phase of a glass and a resin. This is because interfacial strength between the glass layer and the resin layer can be increased, and the refractive index is intermediate between the refractive index of the glass and the refractive index of the resin, thereby making it possible to prevent optical scattering.

### 2) Glass-Resin Sea-Island Composite

FIG. 1C shows a schematic cross-sectional view of a glass-resin sea-island composite according to one embodiment. As shown in FIG. 1C, a glass-resin sea-island composite 21 has a structure in which a particulate glass phase 23, which is a discontinuous phase having a closed interface, is present in a resin phase 22, which is a continuous phase made of a resin. FIG. 1C shows a schematic cross-sectional view of a single-layer glass-resin sea-island composite, but the glass-resin sea-island composite may have a structure including a plurality of layers of two or more layers. From the viewpoint of the formability and the strength, the outermost layer is preferably made of a resin.

In the present description, the term “sea-island structure” refers to a structure in which a discontinuous phase of a component forming a particulate island phase having a closed interface (boundary between phases) is present in a continuous phase of a component forming a sea phase.

In the glass-resin sea-island composite, a content ratio (mass ratio) of the glass phase to the resin phase is preferably 1:99 to 70:30, and more preferably 10:90 to 60:40, from the viewpoints of the gas barrier property and weight reduction.

An interface between the glass phase and the resin phase in the glass-resin sea-island composite is preferably a mixed phase of a glass and a resin. This is because interfacial strength between the glass phase and the resin phase can be increased, and the refractive index is intermediate between the refractive index of the glass and the refractive index of the resin, thereby making it possible to prevent optical scattering.

Examples of a method for producing a glass-resin sea-island composite include a method of separately melting a composite material (for example, a glass-resin composite frit and a glass-resin composite pellet), which is obtained by mixing a glass component (for example, the above glass frit and glass pellet) and a resin component (for example, a resin pellet), and a resin component (for example, a resin pellet), followed by lamination, compositing, low temperature forming such as extrusion forming, injection forming, blow forming, and press forming, and then biaxial stretching.

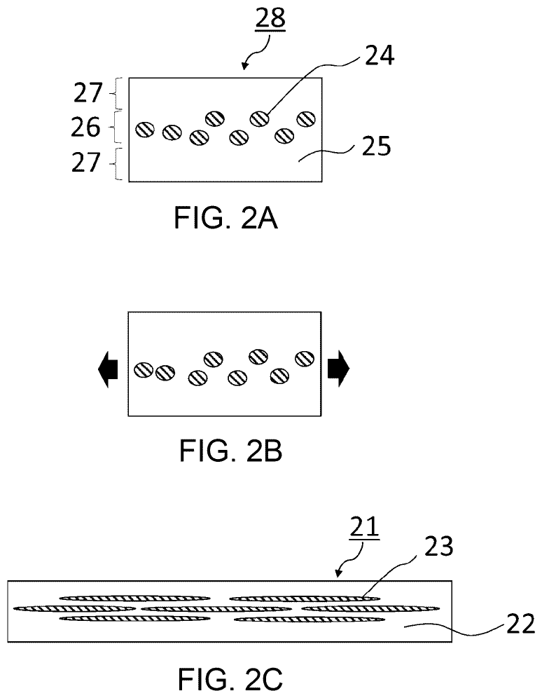

FIG. 2A to FIG. 2C show schematic diagrams showing a method for producing a glass-resin sea-island composite according to one embodiment. FIG. 2A shows a lamination step. The lamination step is a step in which a resin layer 27 is laminated on both surfaces of a layer 26 obtained by compositing a glass component 24 and a resin component 25, thereby obtaining a laminate 28. FIG. 2B shows a stretching and drawing step. The stretching and drawing step is a step in which the laminate obtained in the lamination step is drawn and stretched by biaxial stretching. Accordingly, a glass-resin sea-island composite shown in FIG. 2C is obtained.

### Application

The sintered body or the formed body according to the present invention has excellent transparency, moisture absorption resistance, and gas barrier property, and examples of an application thereof include a food packaging material for highly functional foods, a pharmaceutical packaging material, a pharmaceutical container such as a syringe and an ampoule, a flexible display such as an organic field effect transistor (OLET) cover, a wearable device, or a high frequency film/substrate for use in mobile phones or 5G. Further examples include a color conversion member obtained by dispersing a phosphor (particularly preferably a quantum dot phosphor) for displays (for example, a liquid crystal television or an organic EL television), an airtight sealing material for an MEMS or electronic circuit, a vacuum double-glazed glass sealing material, or a lens (for example, an aspheric lens or a prism lens) and a diffraction grating prepared by press forming or injection forming.

### (Packaging Material)

The above food packaging material for highly functional foods or pharmaceutical packaging material is an example of a PTP (press through package), and can be prepared by simultaneously subjecting a resin and a glass to extrusion forming or by bonding the two together. FIG. 4A and FIG. 4B are schematic cross-sectional views showing an example of a configuration of a packaging material having a sintered body or a formed body according to the present embodiment formed as a part thereof.

As shown in FIG. 4A and FIG. 4B, a packaging material 41 is a laminate in which a resin layer 43 is laminated on a glass layer 42. The number of layers to be laminated is not particularly limited. The laminate may have a configuration in which the resin layer 43 is laminated on both surfaces of the glass layer 42 as shown in FIG. 4B, or may have a configuration including a plurality of layers as shown in FIG. 4A. In the case of the configuration shown in FIG. 4A, the glass layer 42 has a thickness of preferably, for example, 1 μm to 50 μm. In the case of the configuration shown in FIG. 4B, the glass layer 42 has a thickness of preferably, for example, 10 μm to 3 mm.

### (Color Conversion Member Obtained by Dispersing Phosphor)

The above color conversion member obtained by dispersing a phosphor (hereinafter, also referred to as a phosphor-dispersed body) is used in displays such as a liquid crystal television or an organic EL television, or in lighting. Examples of a method for preparing the phosphor-dispersed body include a method of performing low temperature forming (extrusion forming, injection forming, or the like) using a glass pellet in which a phosphor has been dispersed, a method of mixing a phosphor and a glass frit and then performing sintering, and a method of mixing a glass-coated phosphor with a resin pellet and then performing low temperature forming.

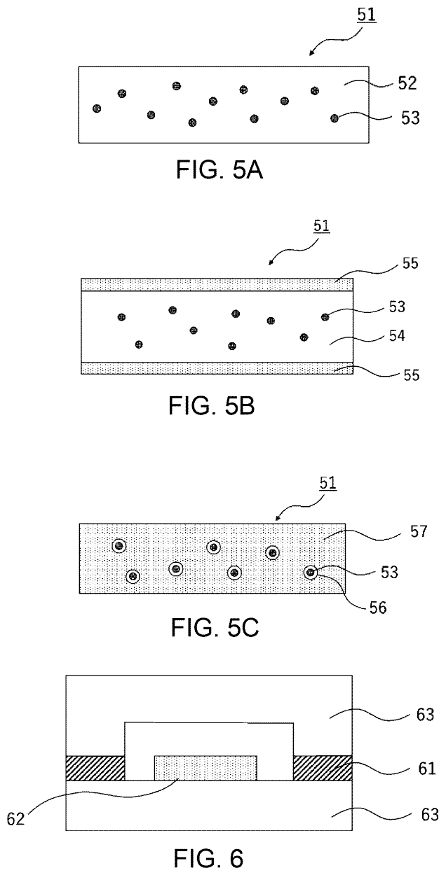

FIG. 5A to FIG. 5C are schematic cross-sectional views showing an example of a configuration of a phosphor-dispersed body having the sintered body or the formed body according to the present embodiment formed as a part thereof. A phosphor-dispersed body 51 shown in FIG. 5A is has a configuration including a layer obtained by dispersing a phosphor 53 in a glass or glass-resin composite 52. In the case of the configuration shown in FIG. 5A, the layer obtained by dispersing the phosphor 53 in the glass or glass-resin composite 52 has a thickness of preferably, for example, 10 μm to 3 mm.

The phosphor-dispersed body 51 shown in FIG. 5B has a configuration in which a resin layer 55 is laminated on both surfaces of a layer obtained by dispersing the phosphor 53 in a glass 54. In the case of the configuration shown in FIG. 5B, the layer obtained by dispersing the phosphor 53 in the glass 54 has a thickness of preferably, for example, 10 μm to 3 mm.

The phosphor-dispersed body 51 shown in FIG. 5C has a configuration including a layer obtained by dispersing the phosphor 53 coated with a coating layer 56 in a resin 57. In the case of the configuration shown in FIG. 5C, the layer obtained by dispersing the phosphor 53 coated with the coating layer 56 in the resin 57 has a thickness of preferably, for example, 10 μm to 3 mm. In the case of the configuration shown in FIG. 5C, the coating layer 56 for coating the phosphor 53 generally has a thickness of preferably 0.001 μm to 1 mm. The coating layer 56 may be made of either an organic substance or an inorganic substance. In order to protect the phosphor 53 from oxygen and moisture and to improve the heat resistance of the phosphor 53, the coating layer 56 is preferably made of an inorganic substance, and a metal, silica, alumina, zirconia, or a glass (particularly the low melting point glass according to the present invention) can be used.

### (Airtight Sealing Material)

FIG. 6 is a schematic cross-sectional view showing an example of a configuration of an airtight sealing material having the sintered body or the formed body according to the present embodiment formed as a part thereof. FIG. 6 shows an example of a configuration in which a glass or a glass-resin composite is used as a sealing material 61 for packaging an MEMS or electronic circuit 62 in a member 63 made of a metal, a ceramic, and the like.

### (Vacuum Double-Glazed Glass Sealing Material)

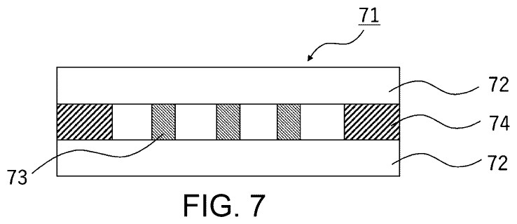

FIG. 7 is a schematic cross-sectional view showing an example of a configuration of a vacuum double-glazed glass having the sintered body or the formed body according to the present embodiment formed as a part thereof. A vacuum double-glazed glass 71 shown in FIG. 7 has a configuration in which a pillar 73 and a glass or glass-resin composite 74 are disposed between two glasses 72.

### (Lens and Diffraction Grating)

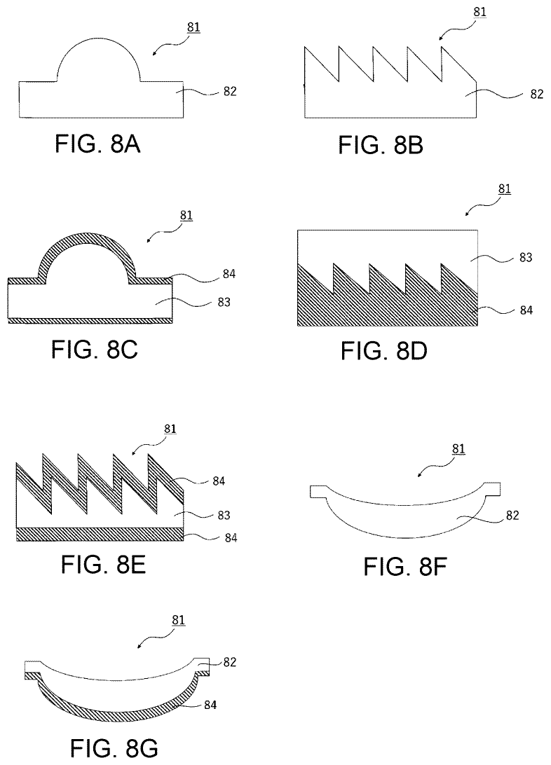

FIG. 8A to FIG. 8G are schematic cross-sectional views showing an example of a configuration of a lens or diffraction grating 81 having the sintered body or the formed body according to the present embodiment formed as a part thereof. As shown in FIG. 8A, FIG. 8B, and FIG. 8F, the lens or diffraction grating 81 may have a configuration made of a glass or glass-resin composite 82 having a curved surface or a shape with protrusions depending on the application. As shown in FIG. 8C, FIG. 8D, and FIG. 8G, the lens or diffraction grating 81 may have a configuration including a glass layer 83 and a resin layer 84. As shown in FIG. 8E, the lens or diffraction grating 81 may have a configuration in which the resin layer 84 is laminated on both surfaces of the glass layer 83. The resin layer 84 is not limited to a resin layer, or may be a layer containing an inorganic substance (for example, an AR film).

### EXAMPLES

Hereinafter, the present invention is described with reference to Examples, but the present invention is not limited thereto.

### <Preparation of Glass>

As described below, glass raw materials were weighed based on a base glass composition, and then the glass raw materials were melted and cast into a mold to obtain a glass block. Base glass composition: composition containing, as represented by mol %, 15% of P, 17.5% of Sn, 42.5% of O, and 25% of F.

### Examples 1 to 12 and 14

As raw materials, H₃PO₄ (concentration: 85%), SnF₂, SnO, ZnF₂, SiO₂, BPO₄, and AlF₃ were used. Each raw material was weighed such that the composition of the glass obtained after melting the raw materials would be each of the compositions shown in the table. For Examples 1 to 10, only H₃PO₄ was dried at 150° C. for 2 hours, and for Example 12, only H₃PO₄ was dried at 170° C. for 4 hours. Thereafter, H₃PO₄ was mixed with all the remaining raw materials. The mixed raw materials were melted in a platinum crucible at 500° C. for 2 hours. The melt was cast into a mold to obtain a glass block. For the obtained glass block, a concentration of F was quantified by an ion electrode method, and concentrations of elements excluding F and O were quantified by ICP atomic emission spectrometry. A concentration of O was calculated based on a difference between a total concentration of other elements and a total concentration. Table 1 shows the quantitative results of compositions, as represented by mol % of element.

### Example 13

A glass block was obtained in the same manner as in Example 1, except that NH₄H₂PO₄, SnO, and SnF₂ were used as the raw materials. Table 1 shows the obtained quantitative results of the composition in the same manner as in Example 1.

### Evaluation

### (Tx, Tg, and Tc)

The glass block was pulverized in an agate mortar to obtain a powder having a median diameter of 0.3 microns. 50 mg of the powder was weighed out and charged into an aluminum pan, and measurement was performed using a differential scanning calorimeter (DSC3300SA manufactured by Bruker) under conditions of raising the temperature from 25° C. to 500° C. at a rate of 2° C./min in an air atmosphere. In a DSC curve, Tg was a temperature at which the curve first underwent an endothermic shift during a temperature rise process, Tx was a temperature at which heat generation due to crystallization first started during the temperature rise process, and Tc was a peak temperature of heat generated due to crystallization that first occurred during the temperature rise process. Note that, when Tx and Tc were not observed, “none” was recorded.

### (Moisture Absorption Amount)

The glass block was left standing in an atmosphere having a temperature of 60° C. and a relative humidity of 90% for 5 hours. The weight was measured before and after standing, and the weight increase amount per unit surface area was calculated as the moisture absorption amount. The results are shown as “moisture absorption amount” in Table 1.

(T_{η=1000(-60° C.)} and T_{η=1000(0° C.)})

The temperature at which the complex viscosity was 1000 Pa·s (T_{η=1000(-60° C.)}) of the glass block was measured using a rheometer (MCR502 manufactured by Anton Paar GmbH) in a dry nitrogen atmosphere in a dew point of −60° C.

The temperature at which the complex viscosity was 1000 Pa·s (T_{η=1000(0° C.)}) of the glass block was measured using a rheometer (MCR502 manufactured by Anton Paar GmbH).

### (Weight Reduction Rate at (Tg+150)° C.)

The glass block was pulverized in an agate mortar to obtain a powder having a median diameter of 0.3 microns. 50 mg of the powder was weighed out and charged into an aluminum pan, and measurement was performed using a thermogravimetric differential thermal analyzer (TG-DTA20000SA manufactured by Bruker) under conditions of raising the temperature from 25° C. to (Tg+150° C.) at a rate of 2° C./min in an air atmosphere and maintaining the temperature at (Tg+150° C.) for 1 hour. The weight reduction rate with respect to the initial weight at this time was evaluated and was shown as “loss (Tg+150)” in Table 1. Note that, in Table 1, blank spaces indicate no evaluation.

### (Infrared Absorption Spectrum)

The glass block was processed into a flat plate having a thickness of 1 mm using cerium oxide free abrasive grains as a finishing agent, and then measurement was performed using a Fourier transform infrared spectrophotometer (Nicolet iS10 manufactured by Thermo Fisher Scientific Inc.) in a wave number range of 400 cm⁻¹ to 4000 cm⁻¹. When a transmittance at a wave number of 400 cm⁻¹ was defined as T400, a transmittance at a wave number of 3100 cm⁻¹ was defined as T3100, and a transmittance at a wave number of 3240 cm⁻¹ was defined as T3240, the absorbance A3100 per 1 mm thickness at a wave number of 3100 cm⁻¹ was calculated according to A3100=−log₁₀(T3100/T400), and the absorbance A3240 per 1 mm thickness at a wave number of 3240 cm⁻¹ was calculated according to A3240=−log₁₀(T3240/T400).

### (Parallel Light Transmittance)

The glass block was processed into a flat plate having a thickness of 1 mm using cerium oxide free abrasive grains as a finishing agent, and then the parallel light transmittance in a wavelength range of 400 nm to 700 nm was measured using an ultraviolet-visible-near infrared spectrophotometer (U4100 manufactured by Hitachi High-Tech Corporation).

The results are shown in Table 1. In Table 1, Examples 1 to 8, 15 and 16 are Inventive Examples, and Examples 9 to 14 are Comparative Examples.

TABLE 1

| | Example | Example | Example | Example | Example | Example | Example | Example |
|---|---|---|---|---|---|---|---|---|
| | 1 | 2 | 3 | 4 | 5 | 6 | 7 | 8 |
| P (mol %) | 13.5 | 14.3 | 14.3 | 13.5 | 14.2 | 14.1 | 13.9 | 14.1 |
| Sn (mol %) | 20.3 | 17.5 | 17.4 | 18.3 | 17.3 | 17.2 | 17.0 | 17.2 |
| Zn (mol %) | 0.0 | 1.9 | 1.1 | 1.1 | 1.1 | 1.8 | 1.8 | 1.0 |
| O (mol %) | 52.7 | 53.5 | 53.0 | 53.2 | 54.3 | 53.4 | 53.8 | 53.2 |
| F (mol %) | 13.5 | 12.8 | 14.2 | 13.8 | 13.0 | 13.5 | 13.4 | 13.8 |
| Si (mol %) | 0.0 | 0.0 | 0.0 | 0.0 | 0.1 | 0.1 | 0.1 | 0.0 |
| B (mol %) | 0.0 | 0.0 | 0.1 | 0.1 | 0.1 | 0.0 | 0.0 | 0.0 |
| Al (mol %) | 0.0 | 0.0 | 0.0 | 0.0 | 0.0 | 0.0 | 0.0 | 0.8 |
| Total | 100.0 | 100.0 | 100.0 | 100.0 | 100.0 | 100.0 | 100.0 | 100.0 |
| (Sn + Zn)/P | 1.50 | 1.35 | 1.30 | 1.44 | 1.30 | 1.35 | 1.35 | 1.30 |
| Tg (° C.) | 91 | 121 | 114 | 102 | 129 | 123 | 128 | 123 |
| Tx (° C.) | None | None | None | None | None | None | None | None |
| Tc (° C.) | None | None | None | None | None | None | None | None |
| Moisture absorption | 1.15 | 2.45 | 2.27 | 2.64 | 0.27 | 1.85 | 1.18 | 4.76 |
| amount (mg/cm²) | | | | | | | | |
| T_{η= 1000(-60° C.)} | 201 | 225 | 222 | 214 | 250 | 228 | 248 | 227 |
| T_{η= 1000(0° C.)} | 235 | 257 | 251 | 229 | 275 | 254 | 277 | 253 |
| T_{η= 1000(0° C.)} − | 34 | 32 | 29 | 15 | 25 | 26 | 29 | 26 |
| T_{η= 1000(-60° C.)} | | | | | | | | |
| A3100 | 1.47 | 1.35 | 1.58 | 2.12 | 2.01 | 1.33 | 1.81 | 1.05 |
| A3240 | 1.24 | 1.15 | 1.34 | 1.81 | 1.71 | 1.13 | 1.54 | 0.89 |
| A3240/A3100 | 0.84 | 0.85 | 0.85 | 0.85 | 0.85 | 0.85 | 0.85 | 0.85 |
| loss (Tg + 150) (wt %) | −0.30 | | −0.18 | | | −0.27 | | |
| Parallel light | | | | | | 86.0 | | |
| transmittance (%) | | | | | | | | |
| | Example | Example | Example | Example | Example | Example | Example | Example |
| | 9 | 10 | 11 | 12 | 13 | 14 | 15 | 16 |
| P (mol %) | 15.3 | 13.0 | 18.9 | 14.7 | 15.8 | 16.2 | 15.3 | 15.2 |
| Sn (mol %) | 14.8 | 18.6 | 15.5 | 18.7 | 18.8 | 19 | 18.7 | 18.5 |
| Zn (mol %) | 3.1 | 1.9 | 0.0 | 1.9 | 0 | 0 | 2.1 | 2.1 |
| O (mol %) | 54.2 | 51.9 | 59.7 | 48.1 | 47.8 | 55.9 | 54.4 | 58.2 |
| F (mol %) | 12.7 | 14.6 | 5.9 | 16.6 | 17.6 | 8.9 | 9.5 | 6.0 |
| Si (mol %) | 0.0 | 0.0 | 0.0 | 0.0 | 0.0 | 0.0 | 0.01 | 0.01 |
| B (mol %) | 0.0 | 0.0 | 0.0 | 0.0 | 0.0 | 0.0 | 0.0 | 0.0 |
| Al (mol %) | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 |
| (Sn + Zn)/P | 1.17 | 1.58 | 0.82 | 1.40 | 1.19 | 1.17 | 1.36 | 1.36 |
| Tg (° C.) | 120 | 100 | 138 | 106 | 130 | 99 | 163 | 188 |
| Tx (° C.) | None | None | None | None | 264 | 248 | None | None |
| Tc (° C.) | None | None | None | None | 276 | 268 | None | None |
| Moisture absorption | 13.55 | 9.85 | 16.20 | 9.73 | 0.07 | 1.05 | 0.00 | 0.00 |
| amount (mg/cm²) | | | | | | | | |
| T_{η= 1000(-60° C.)} | 223 | 211 | 295 | 212 | | | 268 | 298 |
| T_{η= 1000(0° C.)} | 259 | 245 | 330 | 245 | | | 295 | 322 |
| T_{η= 1000(0° C.)} − | 36 | 34 | 35 | 33 | | | 27 | 24 |
| T_{η= 1000(-60° C.)} | | | | | | | | |
| A3100 | 1.10 | 1.11 | 1.16 | 1.29 | 2.69 | 2.34 | 1.11 | 1.03 |
| A3240 | 0.93 | 0.94 | 1.17 | 1.10 | 3.74 | 2.35 | 0.94 | 0.88 |
| A3240/A3100 | 0.85 | 0.85 | 1.01 | 0.85 | 1.39 | 1.00 | 0.85 | 0.85 |
| loss (Tg + 150) (wt %) | | | −0.02 | | −0.86 | −0.76 | −0.12 | |
| Parallel light | | | | | 36.5 | 86.1 | 86.7 | |
| transmittance (%) | | | | | | | | |

As shown in Table 1, in Examples 1 to 8, 15 and 16 as Inventive Examples, the total content of Sn and Zn was 18% to 21%, and the moisture absorption amount was lower than that in Example 9. In addition, in Example 6, A3240/A3100 was 1.2 or less, the moisture content was controlled, and crystallization was less likely to occur, so that a transparent glass was obtained. It is presumed that a glass having excellent transparency can also be obtained in Examples 1 to 5, 7, 8, 15 and 16 in which A3240/A3100 is 1.2 or less. In addition, since no Tc was observed in Examples 1 to 8, 15 and 16, the margin between the formable temperature and the crystallization temperature is widened, and a glass having excellent transparency even during low temperature forming is obtained.

In Example 9 as Comparative Example, Sn is less than 16%, Zn is more than 3%, and (Sn+Zn)/P is less than 1.25, and the moisture absorption amount is high. In Example 10 as Comparative Example, (Sn+Zn)/P is more than 1.55, and the moisture absorption amount is high. In Example 11 as Comparative Example, (Sn+Zn)/P is less than 1.25, and the moisture absorption amount and T_{η=1000(-60° C.)} are greater than those in Examples 1 to 8. In Example 12 as Comparative Example, O was less than 50%, F was more than 15%, and the moisture absorption amount was greater than that in Examples 1 to 8. In Example 13 as Comparative Example, since A3240/A3100 was greater than 1.2, and crystallization was not controlled, a transparent glass could not be obtained. In Example 14 as Comparative Example, P was more than 16%, F was less than 11%, and the differences between Tc and Tg and between Tx and Tg were smaller than that in Examples.

### <Preparation of Glass-Resin Composite and Gas Barrier Property>

A small piece having 5 mm square and having a thickness of 4 mm was cut out from the glass prepared in Example 6, sandwiched between two polyimide resins each having 90 mm square and having a thickness of 125 microns, and pressed at 260° C. to prepare a composite sheet. As a result, the adhesive strength between the glass and the resin was good, and the thickness of the glass layer was 16 microns. The gas barrier property of this composite sheet was measured using a water vapor permeability measuring device (AQUATRAN Model 1 manufactured by MOCON Corporation). As a result, the water vapor permeability was 0.8 g/m²/day, indicating a high gas barrier property.

A small piece having 5 mm square and having a thickness of 4 mm was cut out from the glass prepared in Example 11 as Comparative Example, sandwiched between two polyimide resins each having 90 mm square and having a thickness of 125 microns, and pressed at 260° C. to prepare a composite sheet. As a result, the adhesive strength between the glass and the resin was good, and the thickness of the glass layer was 10 microns. The gas barrier property of this composite sheet was measured using a water vapor permeability measuring device (AQUATRAN Model 1 manufactured by MOCON Corporation). As a result, the water vapor permeability was 8.0 g/m²/day, indicating a low gas barrier property.

A small piece having 50 mm square and having a thickness of 2 mm was cut out from the glass prepared in Example 1, and this small piece was pressed at 260° C. to obtain a circular glass plate having a diameter of 90 mm and a thickness of 757 microns. The gas barrier property of this glass plate was measured using a water vapor permeability measuring device (AQUATRAN Model 1 manufactured by MOCON Corporation). As a result, the water vapor permeability was 0.006 g/m²/day, indicating a high gas barrier property.

The glass prepared in Example 6 was pressed with a carbon mold to prepare a glass pellet having a long diameter of 3 mm and a short diameter of 2.5 mm. This glass pellet and a resin pellet made of a cycloolefin copolymer were subjected to extrusion forming at 240° C. using an extrusion forming machine (manufactured by Souken Co., Ltd.) equipped with a T die having a gap of 0.3 mm. As a result, a glass-resin composite sheet having a thickness of 0.1 mm was obtained. The composite sheet had high transparency, with an average value of parallel light transmittance in the thickness direction in a wavelength range of 400 nm to 700 nm of 75%.

As described above, the following matters are disclosed in the present description.

1. A glass containing, as represented by mol % of element:
12% to 16% of P;
16% to 21% of Sn;
50% to 60% of O;
5% to 15% of F;
0% to 3% of Zn;
0% to 1% of Si;
0% to 1% of B; and
0% to 3% of Al,
in which (Sn+Zn)/P is 1.25 to 1.55,
a glass transition temperature Tg is 80° C. to 200° C., and
when an absorbance per 1 mm thickness at a wave number of 3100 cm⁻¹ is defined as A3100 and an absorbance per 1 mm thickness at a wave number of 3240 cm⁻¹ is defined as A3240 in an infrared absorption spectrum, A3240/A3100 is 0.6 to 1.2.

2. The glass according to the above 1, in which a temperature at which a complex viscosity measured in a dry nitrogen atmosphere in a dew point of −60° C. is 1000 Pa·s is 190° C. to 260° C.

3. The glass according to the above 1 or 2, in which a weight increase amount per unit surface area is 5 mg/cm² or less after storage for 5 hours in an atmosphere at a temperature of 60° C. and a relative humidity of 90%.

4. The glass according to any one of the above 1 to 3, in which the A3100 is 0.2 to 4, and the A3240 is 0.12 to 4.8.

5. The glass according to any one of the above 1 to 4, in which a temperature at which a complex viscosity measured in an air atmosphere in a dew point of 0° C. is 1000 Pa·s is 10° C. or more higher than the temperature at which a complex viscosity measured in a dry nitrogen atmosphere in a dew point of −60° C. is 1000 Pa·s.

6. A frit containing the glass according to any one of the above 1 to 5, in which the frit has an average particle diameter (d50) of 0.5 μm to 10 μm.

7. A pellet containing the glass according to any one of the above 1 to 5, in which the pellet has a long diameter of 0.1 mm to 5 mm.

8. The pellet according to the above 7, having a short diameter of 0.1 mm to 5 mm, and having a ratio of the long diameter to the short diameter of 0.2 to 1.

9. The pellet according to the above 7 or 8, in which the pellet is a glass-resin composite pellet in which a glass and a resin are composited.

10. A sintered body or a formed body, which is obtained by sintering or forming the frit or the pellet according to any one of the above 6 to 9.

11. The sintered body or the formed body according to the above 10, containing
an inorganic substance.

12. The sintered body or the formed body according to the above 10 or 11, containing a phosphor.

13. The sintered body or the formed body according to any one of the above 10 to 12, which is a glass-resin composite.

14. The sintered body or the formed body according to any one of the above 10 to 13, in which a moisture absorption amount per unit surface area is 5 mg/cm² or less after storage for 5 hours in an atmosphere at a temperature of 60° C. and a relative humidity of 90%.

15. A pharmaceutical packaging material containing the sintered body or the formed body according to any one of the above 10 to 14.

16. A food packaging material containing the sintered body or the formed body according to any one of the above 10 to 14.

17. A phosphor-dispersed body containing the sintered body or the formed body according to any one of the above 10 to 14.

18. An airtight sealing material for an MEMS or electronic circuit, containing the sintered body or the formed body according to any one of the above 10 to 14.

19. A sealing material for a vacuum double-glazed glass, containing the sintered body or the formed body according to any one of the above 10 to 14.

20. A lens or a diffraction grating containing the sintered body or the formed body according to any one of the above 10 to 14.

Although the present invention has been described in detail with reference to specific aspects, it is apparent to those skilled in the art that various changes and modifications can be made without departing from the spirit and scope of the present invention. Note that, the present application is based on a Japanese patent application (Japanese Patent Application No. 2022-032183) filed on Mar. 2, 2022, the entire contents of which are incorporated herein by reference. In addition, all references cited here are entirely incorporated.

1. A glass comprising, as represented by mol % of element:
12% to 16% of P;
16% to 21% of Sn;
50% to 60% of O;
5% to 15% of F;
0% to 3% of Zn;
0% to 1% of Si;
0% to 1% of B; and
0% to 3% of Al,
wherein (Sn+Zn)/P is 1.25 to 1.55,
a glass transition temperature Tg is 80° C. to 200° C., and
when an absorbance per 1 mm thickness at a wave number of 3100 cm⁻¹ is defined as A3100 and an absorbance per 1 mm thickness at a wave number of 3240 cm⁻¹ is defined as A3240 in an infrared absorption spectrum, A3240/A3100 is 0.6 to 1.2.

2. The glass according to claim 1, wherein a temperature at which a complex viscosity measured in a dry nitrogen atmosphere in a dew point of −60° C. is 1000 Pa·s is 190° C. to 260° C.

3. The glass according to claim 1, wherein a weight increase amount per unit surface area is 5 mg/cm² or less after storage for 5 hours in an atmosphere at a temperature of 60° C. and a relative humidity of 90%.

4. The glass according to claim 1, wherein the A3100 is 0.2 to 4, and the A3240 is 0.12 to 4.8.

5. The glass according to claim 1, wherein a temperature at which a complex viscosity measured in an air atmosphere in a dew point of 0° C. is 1000 Pa·s is 10° C. or more higher than a temperature at which a complex viscosity measured in a dry nitrogen atmosphere in a dew point of −60° C. is 1000 Pa·s.

6. A frit comprising the glass according to claim 1, wherein the frit has an average particle diameter (d50) of 0.5 μm to 10 μm.

7. A pellet comprising the glass according to claim 1, wherein the pellet has a long diameter of 0.1 mm to 5 mm.

8. The pellet according to claim 7, having a short diameter of 0.1 mm to 5 mm, and having a ratio of the short diameter to the long diameter of 0.2 to 1.

9. The pellet according to claim 7, wherein the pellet is a glass-resin composite pellet in which a glass and a resin are composited.

10. A sintered body or a formed body, which is obtained by sintering or forming the frit according to claim 6.

11. The sintered body or the formed body according to claim 10, comprising an inorganic substance.

12. The sintered body or the formed body according to claim 10, comprising a phosphor.

13. The sintered body or the formed body according to claim 10, which is a glass-resin composite.

14. The sintered body or the formed body according to claim 10, wherein a moisture absorption amount per unit surface area is 5 mg/cm² or less after storage for 5 hours in an atmosphere at a temperature of 60° C. and a relative humidity of 90%.

15. A pharmaceutical packaging material comprising the sintered body or the formed body according to claim 10.

16. A food packaging material comprising the sintered body or the formed body according to claim 10.

17. A phosphor-dispersed body comprising the sintered body or the formed body according to claim 10.

18. An airtight sealing material for an MEMS or electronic circuit, comprising the sintered body or the formed body according to claim 10.

19. A scaling material for a vacuum double-glazed glass, comprising the sintered body or the formed body according to claim 10.

20. A lens or a diffraction grating comprising the sintered body or the formed body according to claim 10.
